(19) United States
(12) Patent Application Publication
(10) Pub. No.: US 2010/0096460 A1
(43) Pub. Date: Apr. 22, 2010

(54) Hybrid laser scanning and imaging reader

(76) Inventors: Bradley Carlson, Huntington, NY (US); Edward Barkan, Miller Place, NY (US); John Evans, Levittown, NY (US); John Fioriglio, Rocky Point, NY (US)

Correspondence Address: MOTOROLA, INC., 1303 EAST ALGONQUIN ROAD, IL01/3RD, SCHAUMBURG, IL, 60196, US

(21) Appl. No.: 12/288,127

(22) Filed: Oct. 16, 2008

(51) Int. Cl. G06K 7/10

(52) U.S. Cl. 235/462.07

(57) ABSTRACT

An imaging module is supported by a housing of a reader for electro-optically reading indicia. The imaging module includes a solid-state imager having an array of image sensors for capturing return light from the indicia during reading. A laser scanning( module is also supported by the housing and includes a scanner for scanning at least one of a laser beam from a laser and a field of view of a light detector in a scan pattern across the indicia during reading. A controller is operatively connected to the modules, and is operative for distinguishing between types of the indicia, and for enabling the laser scanning module to read one-dimensional symbols by default, and for automatically enabling the imaging module to read two-dimensional symbols upon detection that a symbol being read is a two-dimensional symbol.

### DESCRIPTION OF THE RELATED ART

Moving laser beam-based readers, in both handheld and hands-flee modes of operation, have been used to electro-optically read coded symbols, particularly one-dimensional Universal Product Code (UPC) type symbols, in supermarkets, warehouse clubs, department stores, and other kinds of retailers for many years. A laser generates a laser beam directed to a symbol associated with a product for reflection and scattering from the symbol. A detector having a field of view detects light of variable intensity returning from the symbol. A scanner scans at least one of the laser beam and the field of view in a scan pattern comprised of one or more scan lines. When at least one of the scan lines sweeps over the symbol, an electrical analog signal indicative of the intensity of the detected return light is processed, digitized and decoded by signal processing circuitry including a microprocessor; the symbol is read; and the product is identified.

Imager-based readers, in both handheld and hands-free modes of operation, have also been used to electro-optically read targets such as coded symbols, particularly two-dimensional symbols, by employing solid-state imagers to capture an image of each symbol. The imager comprises an array of cells or photosensors, which correspond to image elements or pixels in a field of view of the imager. Such an array may be comprised of a one- or two-dimensional charge coupled device (CCD) or a complementary metal oxide semiconductor (CMOS) device, analogous to those devices used in digital cameras to capture images.

The imager-based reader further typically includes an illuminator to illuminate the symbol during its reading with illumination light emitted from an illumination light source and directed to the symbol for reflection therefrom. The illumination light source may be located within and/or externally of the reader, and typically comprises one or more light emitting diodes (LEDs). The imager-based reader yet further includes electronic circuitry for processing electrical signals indicative of the light captured by the array, and a microprocessor for decoding the electrical signals to read each captured image.

It is therefore known to use a solid-state imager for capturing a monochrome image of a symbol as, for example, disclosed in U.S. Pat. No. 5,703,349. It is also known to use a solid-state imager with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

In the hands-free mode of either the moving laser beam-based reader or the imager-based reader, an operator may slide or swipe the product bearing the symbol past a window of either reader in either horizontal and/or vertical and/or diagonal directions, in a “swipe” mode. Alternatively, the operator may present the symbol on the product to an approximate central region of the respective window in a “presentation” mode. The choice depends on operator preference or on the layout of a workstation in which the reader is used.

In the handheld mode of either the moving laser beam-based reader or the imager-based reader, the operator holds the respective reader in his or her hand during reading and aims the reader at the symbol to be read. The operator may first lift the reader from a countertop or a support cradle. Once reading is completed, the operator may return the reader to the countertop or to the support cradle.

Although the moving laser beam-based reader and the imager-based reader are generally satisfactory for their intended purposes, their capabilities are limited in certain respects. The moving laser beam-based reader works well, especially in the handheld mode, when reading one-dimensional symbols, but does not read certain two-dimensional symbols as well as the imager-based reader can, and cannot read other two-dimensional symbols at all. The imager-based reader, on the other hand, works well, especially in the hands-free mode, for reading two-dimensional symbols. It would be desirable to have a single reader capable of reading both one- and two-dimensional symbols well.

### SUMMARY OF THE INVENTION

One feature of the present invention resides, briefly stated, in a reader for, and a method of, electro-optically reading indicia, especially one- and/or two-dimensional symbols. Each symbol includes elements of different light reflectivity, e.g., bars and spaces. The reader could be configured, in one embodiment, as a hands-free and/or a hand-held housing having a window. The housing may have a handle for handheld operation and/or a base for supporting the housing on a support surface for hands-free operation. Also, the housing is preferably configured with a gun-shaped configuration, and a manually actuatable trigger is provided on the housing at a location underlying an operator's forefinger when the operator holds the handle in the operator's hand. In another embodiment, the reader could be configured as a stationary bi-optic housing having dual windows.

In some applications, each window could be omitted, in which event, the reader has a windowless opening at which the indicia are located for reading. As used herein, the term “presentation area” is intended to cover both a window and a windowless opening. In the case of the hands-free reader, the symbol is swiped past, or presented to, the presentation area and, in the case of the handheld reader, the reader itself is moved and the presentation area is aimed at the symbol. In the preferred embodiments, the reader is installed in a retail establishment, such as a supermarket, especially in a cramped environment.

An imaging module is supported by the housing, and includes a two-dimensional, solid-state imager mounted in the reader. The imager has an array of image sensors operative, together with a focusing lens assembly, for capturing light from a two-dimensional symbol or target through the presentation area during the reading to produce a captured image. Preferably, the array is a CCD or a CMOS array. When the reader is operated in low light or dark ambient environments, the imaging module includes an illuminator for illuminating the symbol during the reading with illumination light directed from an illumination light source through the presentation area. The illumination light source typically comprises one or more light emitting diodes (LEDs).

A laser scanning module is also supported by the housing and includes a scanner for scanning at least one of a laser beam from a laser and a field of view of a light detector in a scan pattern, typically comprised of one or more scan lines, across the indicia during reading. The laser scanning module may also include signal processing circuitry for processing an electrical analog signal generated by the light detector, and a digitizer for converting the analog signal to a digital signal for subsequent decoding.

In accordance with one aspect of this invention, a controller, especially but not necessarily operative for decoding the digital signal, is operatively connected to the modules, for distinguishing between types of the indicia, e.g., one- or two-dimensional symbols, and for enabling one of the modules to read the indicia of one distinguished type, and for enabling another of the modules to read the indicia of another distinguished type. For example, the controller is operative for distinguishing between one-dimensional and two-dimensional symbols, and for enabling the laser scanning module to read the one-dimensional symbols for which the laser scanning module is better suited, and for enabling the imaging module to read the two-dimensional symbols for which the imaging module is better suited.

In the preferred embodiment, the controller is operative for enabling the laser scanning module to read the one-dimensional symbols by default, for detecting whether a symbol being read is a two-dimensional symbol, and for automatically enabling the imaging module to read the two-dimensional symbol upon detection by the controller. Advantageously, the controller is operative for detecting whether the symbol being read is a two-dimensional symbol by recognizing symbol parameters, such as start and stop patterns, which are characteristic of a two-dimensional symbol.

The invention additionally resides in a method of electro-optically reading indicia, performed by supporting an imaging module by a housing, capturing return light from the indicia during reading with a solid-state imager having an array of image sensors, supporting a laser scanning module by the housing, scanning at least one of a laser beam from a laser and a field of view of a light detector in a scan pattern across the indicia during reading, distinguishing between types of the indicia, enabling one of the modules to read the indicia of one determined type, e.g., one-dimensional symbols, by default, by the laser scanning module, and enabling another of the modules to read the indicia of another determined type, e.g., two-dimensional symbols, by an automatic changeover, by the imaging module.

Hence, this invention proposes a hybrid, dual module, reader that call be used for hands-free and/or handheld reading of one- and/or two-dimensional symbols. The laser scanning module is used for reading one-dimensional symbols, and the imaging module is used for reading two-dimensional symbols.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an electro-optical reader operative in either a hand-held mode and/or a hands-free mode, for reading indicia in accordance with this invention;

FIG. 2 is a broken-away, sectional view of the reader of FIG. 1 schematically depicting various components therein;

FIG. 3 is a perspective view of a bi-optical reader operative for reading indicia in accordance with this invention;

FIG. 4 is a broken-away, sectional view of the reader of FIG. 3 schematically depicting various components therein; and

FIG. 5 is a flow chart depicting aspects of the operation of a controller for use in the reader of FIG. 1 or FIG. 3.

### DETAILED DESCRIPTION OF THE PREFERRED EMBODIMENTS

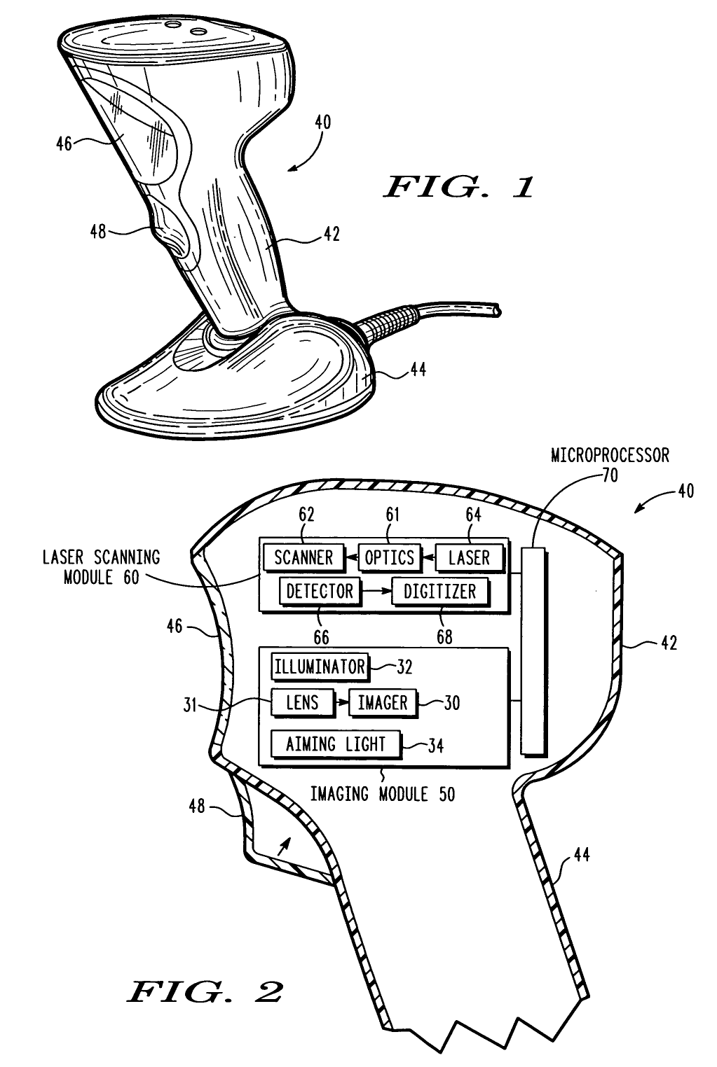

Reference numeral 40 in FIG. 1 generally identifies an electro-optical, portable reader having a gun-shaped housing 42 connected to a base 44. The base 44 rests on a countertop or analogous support surface and serves for supporting the reader 40. The reader 40 can thus be used in a hands-free mode as a stationary workstation in which products bearing indicia, such as one- or two-dimensional symbols, are presented to, or slid or swiped past, a presentation area or window 46. The gun-shaped housing 42 also has a handle that can be picked up by an operator off the countertop and held in the operator's hand in a handheld mode. A trigger 48 is located on the gun-shaped housing 42 at a location underlying an operator's forefinger when the operator holds the handle in the operator's hand in the handheld mode. The trigger 48 is manually depressed to initiate reading of the symbol. The handle is permanently and pivotably connected to the base 44 in both the handheld and hands-free modes for pivoting movement about a generally horizontal pivot axis that is generally parallel to, and elevated above, the countertop. The housing is adjustably tiltable forward and back about the pivot axis in the hands-free mode to aim the window 46 at the symbol to be read.

An imaging module 50 is supported by the housing 42, and includes a two-dimensional, solid-state imager 30 mounted in the reader. The imager 30 has an array of image sensors operative, together with a focusing lens assembly 31, for capturing light from a two-dimensional symbol or target through the presentation area 46 during the reading to produce an electrical signal indicative of a captured image for subsequent decoding. Preferably, the array is a CCD or a CMOS array. When the reader 40 is operated in low light or dark ambient environments, the imaging module 50 includes an illuminator 32 for illuminating the symbol during the reading with illumination light directed from an illumination light source through the presentation area 46. The illumination light source comprises one or more light emitting diodes (LEDs). An aiming light generator 34 may also be provided for projecting an aiming light pattern or mark on the symbol prior to reading.

In operation of the imaging module 50, a controller 70, as described below sends a command signal to pulse the illuminator LEDs 32 for a short time period, say 500 microseconds or less, and energizes the imager 40 during an exposure time period of a frame to collect light from a target symbol during said time period. A typical array needs about 33 milliseconds to read the entire target image and operates at a frame rate of about 30 frames per second. The array may have on the order of one million addressable image sensors.

A laser scanning module 60 is also supported by the housing 42 and includes a scanner 62 for scanning at least one of a laser beam from a laser 64 and a field of view of a light detector 66 in a scan pattern, typically comprised of one or more scan lines across the indicia during reading. The laser scanning module 60 may also include optics 61 for focusing the laser beam to have a large depth of field, and a digitizer 68 for converting an electrical analog signal generated by the detector 66 into a digital signal for subsequent decoding,

In operation of the laser scanning module 60, the controller 70, as described below, energizes the laser to emit the laser beam, and energizes the scanner to sweep the laser beam in the scan pattern. The controller 70 also processes and decodes the digitized signal from the digitizer 68.

In accordance with one aspect of this invention, a programmed microprocessor or controller 70, especially but not necessarily operative for decoding the digital signal from the digitizer 68 or the electrical signal indicative of the captured image from the imager 30, is operatively connected to the modules 50, 60 for distinguishing between types of the indicia, e.g., one- or two-dimensional symbols, and for enabling one of the modules to read the indicia of one determined type, and for enabling another of the modules to read the indicia of another determined type. For example, the controller 70 is operative for distinguishing between one-dimensional and two-dimensional symbols, and for enabling the laser scanning module 60 to read the one-dimensional symbols for which the laser scanning module 60 is better suited, and for enabling the imaging module 50 to read the two-dimensional symbols for which the imaging module 50 is better suited.

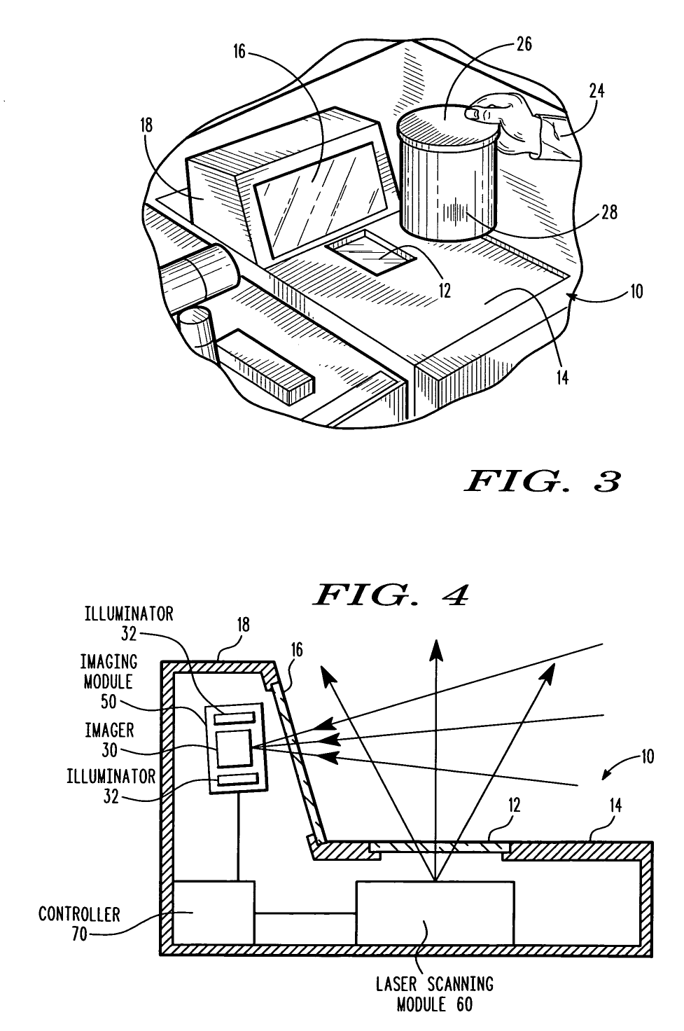

FIG. 3 depicts a dual window, bi-optic, point-of-transaction reader having a housing 10 used by retailers to process transactions involving the purchase of products bearing an identifying symbol, typically the UPC symbol described above. Housing 10 has a generally horizontal window 12 set flush into a countertop 14, and an upright window 16 set flush, or recessed, into a raised housing portion 18 above the countertop 14. An operator 24 is shown holding a product 26 bearing a symbol 28.

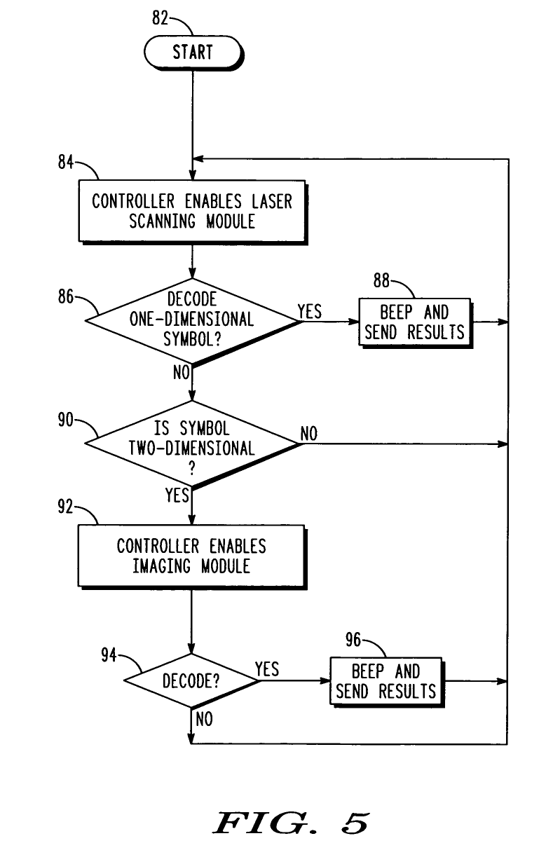

As shown in FIG. 4, the imaging module 50 including the imager 30 and the illuminator 32 is mounted in the bi-optic housing 10. The laser scanning module 60 is also mounted in the bi-optic housing 10. The modules 50, 60 could be dedicated to individual windows as illustrated, or could share one or both of the windows 12, 16. The modules 50, 60 are operatively connected to the controller 70 operative, as described above, for controlling the operation of these modules. Preferably, the controller 70 is the same as the one used for decoding light scattered from the indicia and for processing and analyzing the captured target images.

In either reader embodiment of FIGS. 1-2 or FIGS. 3-4, the controller 70 is operative for enabling the laser scanning module 60 to read the one-dimensional symbols by default, for detecting whether a symbol being read is a two-dimensional symbol, and for automatically enabling the imaging module 50 to read the two-dimensional symbol upon detection by the controller 70. Advantageously, the controller 70 is operative for detecting whether the symbol being read is a two-dimensional symbol by recognizing symbol parameters, such as start and stop patterns, which are characteristic of a two-dimensional symbol.

This operation of the controller 70 is illustrated in FIG. 5, in which beginning from a start block 82, the controller 70 enables the laser scanning module 60 (block 84) to decode a one-dimensional symbol (block 86) by default. If successful, a beeper is sounded, or a visual indicator light is lit, and the results are sent (block 88) to a host. If not successful, then the controller 70 performs an auto-discrimination function at block 90 to determine whether the symbol is two-dimensional. If so, then the controller 70 automatically enables the imaging module 50 (block 92) to decode the two-dimensional symbol (block 94). If successful, a beeper is sounded, or a visual indicator light is lit, and the results are sent (block 96) to the host. If not successful, then the controller 70 returns to its default state. Details of the auto-discrimination function are known in the art, and reference may be had to U.S. Pat. No. 6,328,213 and U.S. Pat. No. 6,250,551, the entire contents of which are hereby incorporated her-in by reference thereto.

Thus, the laser scanning module 60 becomes the primary reading module, and one-dimensional symbols typically represent the majority of symbols to be read. Occasionally, the operator may want to read a two-dimensional symbol, often printed on a driver's license, for age verification that a consumer is eligible to buy a product such as alcoholic beverages or tobacco. The operator can aim the reader at the two-dimensional symbol, or vice versa, and the controller 70 can recognize that it is looking at a two-dimensional symbol by the unique start/stop characters of the two-dimensional symbol, or by the structure of the internal characters. When this happens, the imaging module 50 will be automatically enabled by the controller 70 to read the two-dimensional symbol.

Hence, this invention proposes a hybrid, dual module, reader that can be used for hands-free and/or handheld reading of one- and/or two-dimensional symbols. The laser scanning module 60 is used for reading one-dimensional symbols, and the imaging module 50 is used for reading two-dimensional symbols.

It will be understood that each of the elements described above, or two or more together, also may find a useful application in other types of constructions differing from the types described above. Thus, readers having different configurations can be used.

While the invention has been illustrated and described as integrating a laser scanning module and an imaging module in a hybrid reader and method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. A reader for electro-optically reading indicia, comprising:
a housing;
an imaging module supported by the housing and including a solid-state imager having an array of image sensors for capturing return light from the indicia during reading;
a laser scanning module supported by the housing and including a scanner for scanning at least one of a laser beam from a laser and a field of view of al light detector in a scan pattern across the indicia during reading; and
a controller operatively connected to the modules, for distinguishing between types of the indicia, and for enabling one of the modules to read the indicia of one distinguished type, and for enabling another of the modules to read the indicia of another distinguished type.

2. The reader of claim 1, wherein the controller is operative for distinguishing between one-dimensional and two-dimensional symbols, and wherein the controller is operative for enabling the laser scanning module to read the one-dimensional symbols, and for enabling the imaging module to read the two-dimensional symbols.

3. The reader of claim 2, wherein the controller is operative for enabling the laser scanning module to read the one-dimensional symbols by default, and wherein the controller is operative for detecting whether a symbol being read is a two-dimensional symbol and for automatically enabling the imaging module to read the two-dimensional symbol upon detection by the controller.

4. The reader of claim 3, wherein the controller is operative for detecting whether the symbol being read is a two-dimensional symbol by recognizing symbol parameters characteristic of a two-dimensional symbol.

5. The reader of claim 1, wherein the housing has a handle to be held by an operator in a handheld mode of operation.

6. The reader of claim 1, wherein the housing has a presentation area and wherein the laser directs the laser beam through the presentation area to the indicia for reflection therefrom, and wherein the imager captures the return light from the indicia through the presentation area.

7. The reader of claim 1, wherein the housing has dual presentation areas, and wherein the laser directs the laser beam through one of the presentation areas to the indicia for reflection therefrom, and wherein the imager captures the return light from the indicia through another of the presentation areas.

8. A method of electro-optically reading indicia, comprising the steps of:
supporting an imaging module by a housing, and capturing return light from the indicia during reading with a solid-state imager having an array of image sensors;
supporting a laser scanning module by the housing, and scanning at least one of a laser beam from a laser and a field of view of a light detector in a scan pattern across the indicia during reading; and
distinguishing between types of the indicia, and enabling one of the modules to read the indicia of one distinguished type, and enabling another of the modules to read the indicia of another distinguished type.

9. The method of claim 8, wherein the distinguishing step is performed by distinguishing between one-dimensional and two-dimensional symbols, wherein the step of enabling the one module is performed by enabling the laser scanning module to read the one-dimensional symbols, and wherein the step of enabling the other module is performed by enabling the imaging module to read the two-dimensional symbols.

10. The method of claim 9, wherein the step of enabling the laser scanning module is performed by default, wherein the distinguishing step is performed by detecting whether a symbol being read is a two-dimensional symbol, and wherein the step of enabling the imaging module is performed automatically upon detection of the two-dimensional symbol.

11. The method of claim 10, wherein the detecting step is performed by recognizing symbol parameters characteristic of a two-dimensional symbol.

12. The method of claim 8, and the step of configuring the housing with a handle to be held by an operator in a handheld mode of operation.

13. The method of claim 8, and the step of configuring the housing with a presentation area, wherein the scanning step is performed by directing the laser beam through the presentation area to the indicia for reflection therefrom, and wherein the capturing step is performed by capturing the return light from the indicia through the presentation area.

14. The method of claim 8, and the step of configuring the housing with dual presentation areas, wherein the scanning step is performed by directing the laser beam through one of the presentation areas to the indicia for reflection therefrom, and wherein the capturing step is performed by capturing the return light from the indicia through another of the presentation areas.
